(19) United States
(12) Patent Application Publication
(10) Pub. No.: US 2006/0132641 A1
(43) Pub. Date: Jun. 22, 2006

(54) Optical filter and image pickup apparatus having the same

(76) Inventor: Shingo Hayakawa, Yokohama-shi (JP)

Correspondence Address: MORGAN & FINNEGAN, L.L.P., 3 WORLD FINANCIAL CENTER, NEW YORK, NY, 10281-2101, US

(21) Appl. No.: 11/265,327

(22) Filed: Nov. 1, 2005

(30) Foreign Application Priority Data
Nov. 1, 2004 (JP) 2004-318201 (PAT,

(51) Int. Cl. H04N 5/225

(52) U.S. Cl. 348/342

(57) ABSTRACT

A wavelength selective member for intercepting the passage of a beam of a predetermined wavelength range is disposed on a light incidence side of an optical member formed of an organic material having optical anisotropy, to thereby provide an optical filter which suffers little from the deterioration of performance with the passage of time by near ultraviolet rays, etc.

### BACKGROUND OF THE INVENTION

1. Field of the Invention

This invention relates to an optical filter disposed in the optical path of an image pickup apparatus which effects image pickup by a solid image pickup element, and is suitable for an image pickup apparatus such as, for example, a digital camera or a video camera using a solid image pickup element.

2. Description of the Related Art

Heretofore, in an image pickup apparatus using a solid image pickup element such as a CCD or a CMOS, an optical low-pass filter has been disposed in an optical path. The optical low-pass filter has the function of reducing a false signal generated depending on the sampling frequency of the image pickup element when the image of an object having a high frequency component is picked up.

The image pickup element such as a CCD or a CMOS has two-dimensionally regularly arranged pixels and a color filter. Therefore, it is desirable to design it so as to appropriately control the response of spatial frequencies in at least two directions. From such a background, there is known an optical low-pass filter in which a first quartz birefringence plate, a quartz phase plate and a second quartz birefringence plate are disposed in the named order so as to control response with respect to two, that is, horizontal and vertical directions which are the ordinary arrangement directions of the image pickup element.

Also, there have been proposed various constructions in which an optical low-pass filter is constructed by utilizing the birefringence action of an organic substance such as a liquid crystal material (see Japanese Patent Application Laid-open No. H06-317776, Japanese Patent Application Laid-open No. H08-122708 (corresponding to U.S. Pat. No. 5,820,779, and Japanese Patent Application Laid-open No. H11-305168 (corresponding to U.S. Patent AA200210/559)).

In Japanese Patent Application Laid-open No. H06-317776, Japanese Patent Application Laid-open No. H08-122708 and Japanese Patent Application Laid-open No. H11-305168, it is disclosed that a liquid crystal material which can be given a birefringent property by applying an electric field or a magnetic field thereto is used as an optical low-pass filter.

There has also been proposed an optical low-pass filter using a film-like organic material having optical anisotropy, instead of a quartz phase plate (see Japanese Patent Application Laid-open No. 2002-303826).

The conventional optical low-pass filter utilizing quartz uses a uniaxial single crystal birefringence plate and a phase plate and therefore, the production of a material and the working of a substrate can be stably performed at a relatively low cost. However, the difference between the refractive indices of an ordinary ray and an extraordinary ray is not so great and therefore, even when a single crystal substrate is used most efficiently, there has been the problem that the thickness of the single crystal substrate necessary to obtain the desired separation width of a ray of light becomes great.

In contrast, there is also known an optical low-pass filter using lithium niobate which., as compared with quartz, is great in the difference of refractive index between the ordinary ray and the extraordinary ray. The optical low-pass filter using lithium niobate enables the entire optical low-pass filter to be formed thinly as compared with a case where the quartz is used, even when the separation widths of the ordinary ray and the extraordinary ray are made equal to each other.

The single crystal material of lithium niobate, however, conversely requires to be thinly worked for use, and is difficult in the working of a polished substrate due to the hardness or the like of the material itself. Also, it is a material having a high refractive index and therefore also requires a high degree of anti-reflection processing.

When as disclosed in Japanese Patent Application Laid-open No. H08-122708 and Japanese Patent Application Laid-open No. H11-305168 (corresponding U.S. Patent AA2002101559), a film-like organic material is used as an optical low-pass filter, a great majority of organic materials cause a chemical change by the application of near ultraviolet rays thereto. As a result, there is the problem that in appearance, such material exhibits yellowing deterioration. This problem of yellowing deterioration is a problem which cannot be neglected in an optical apparatus such as a camera supposed to be exposed to sunlight. When a reduction in the transmissivity of a visible wavelength range is caused by yellowing deterioration, the color reproducibility of an object image becomes remarkably bad.

### SUMMARY OF THE INVENTION

The present invention has as its object the provision of a thin type optical filter which suffers little from performance deterioration with the passage of time.

The illustrative optical filter of the present invention is characterized by an optical member formed of an organic material having optical anisotropy, and a wavelength selecting member disposed more adjacent to a light incidence side than the optical member for intercepting the passage of a beam of a predetermined wavelength range.

### BRIEF DESCRIPTION OF THE DRAWINGS

FIG. 1 is a cross-sectional view of the essential portions of a single lens reflex camera using an optical filter according to Embodiment 1.

FIGS. 2A and 2B are illustrations of the optical filter according to Embodiment 1.

FIG. 3 is a spectral characteristic graph of the optical filter according to Embodiment 1.

FIG. 4 is an illustration of the spectral sensitivity of an image pickup element, etc. in Embodiment 1.

FIG. 5 is an illustration of the color signals of an image pickup apparatus according to Embodiment 1.

FIGS. 6A and 6B are illustrations of an optical filter according to Embodiment 2.

FIGS. 7A and 7B are illustrations of an optical filter according to Embodiment 3.

### DESCRIPTION OF THE PREFERRED EMBODIMENTS

The epitome of this embodiment will first be described.

The present embodiment realizes an optical filter suitable for a camera (image pickup apparatus) for forming a color image by an image pickup element having color filters in which R (red), G (green) and B (blue) colors are arranged in a mosaic-like manner.

In a camera for forming a color image by an image pickup element having color filters in which respective colors are arranged in a mosaic-like manner, design is generally made such that the arrangement of the color filters has predetermined regularity. The luminance signal of each pixel of such an image pickup element is outputted on the basis of the luminance signal of a pixel corresponding to a predetermined color (e.g. G). Specifically describing, the luminance signal of a pixel in which a color filter of the predetermined color is not disposed is designed to be formed by being suitably interpolated by the use of the luminance signal of a pixel existing around it and in which the color filter of the predetermined color is disposed. At this time, the signal formed by the interpolation generates a false signal in a relatively high spatial frequency conforming to the pitch of the interpolation, and appears in an image as a false color signal determined by the arrangement of the color filters. In an image pickup element in which pixels and color filters are two-dimensionally arranged, this false color signal is generated in particular spatial frequencies in directions having regularity in the arrangement thereof, generally horizontal, vertical and oblique directions.

So, an image pickup system using an image pickup element is required to be provided with an optical low-pass filter to reduce response to the spatial frequencies in these two-dimensional directions with a view to reduce the intensity of such a false color signal. To reduce the response two-dimensionally as described above, it becomes necessary to two-dimensionally operate a ray of light traveling from a photo-taking lens to the image pickup element.

A filter member in the present embodiment is constituted by a suitable combination of one or more optical members (organic optical members) formed of an organic material having optical anisotropy, and a selective wavelength member. Of course, by such a construction, the ray of light traveling from the photo-taking lens to the image pickup element is two-dimensionally separated and the response to a predetermined spatial frequency is two-dimensionally reduced, and the use of the thin organic material enables the optical low-pass filter to be constructed sufficiently thinly. Further, a wavelength selective member suppressing the passage of near ultraviolet rays harmful to the organic material is provided more adjacent to a light incidence side than the organic optical members to thereby prevent the optical filter itself from deteriorating.

In an image pickup element having square pixels, as a technique of reducing the intensity of a false color signal generated by the arrangement of color filters, there is known, for example, a technique of providing an optical low-pass filter having the function of separating a ray of light traveling from a photo-taking lens to an image pickup element into two, that is, horizontal and vertical directions, and forming four object images on the image pickup element. By adopting such a construction, it becomes possible to appropriately reduce response to a particular spatial frequency generating false color signals in horizontal, vertical and oblique directions.

As another technique, there is known a technique of providing an optical low-pass filter having the function of separating a ray of light into two directions, i.e., a first oblique direction of 45° and a second oblique direction of 45° with respect to a horizontal line, and also forming four object images.

In the image pickup element having square pixels, the directions in which the false color signals are strongly generated are horizontal, vertical and two oblique 45° directions. Therefore, to efficiently reduce these false color signals, it is desirable to adopt a construction which separates an image into two directions orthogonal to each other, as in the above-described two techniques.

An organic material having uniaxiality is supposed to be used as the film-like organic material used in the present embodiment. However, from the action of each material, materials having different characteristics may be used in combination. That is, for example, as a first optical member for separating an ordinary ray and an extraordinary ray in a plane perpendicular to an optical axis by birefringent action, use is made of an organic material adapted to have birefringence with the orientation of the moleculars of a liquid crystalline material as a predetermined direction. Also, as a second optical member for converting the phase difference between the ordinary ray and the extraordinary ray by phase difference converting action, use is made of an organic material having a predetermined thickness extended in the predetermined direction so as to have uniaxiality. Further, as a third optical member for separating the ordinary ray and the extraordinary ray in a plane perpendicular to the optical axis by birefringent action, use is made of an organic material adapted to have birefringence with the orientation of the molecules of the liquid crystalline material as a predetermined direction. Of course, as any one of the optical members, use may be made of a single crystal substrate of quartz or lithium niobate.

The photoelectric converting action of silicon is utilized in a solid-state image pickup element such as a CCD or a CMOS. Therefore, the image pickup element, although there is the difference due to the detailed structure thereof, has spectral sensitivity generally determined by the photoelectric converting characteristic of silicon. Accordingly, when a photographing apparatus is to be constructed, it is necessary to provide a visibility correcting filter for correcting the difference between the spectral sensitivity and visibility of the image pickup element. So, it is popular to use a color glass filter or vapor-deposited film of a dielectric material as an optical filter with a view to chiefly intercept near infrared rays for the correction of visibility.

An attempt to intercept a ray of a harmful wavelength range by only a color glass filter would result in a reduction in the transmissivity of a visible wavelength range, i.e., a reduction in sensitivity. On the other hand, an attempt to intercept the ray of a harmful wavelength range by only dielectric material vapor-deposited film would lead to a case where harmful light becomes reflected light and causes the occurrence of a ghost. So, it is desired to use an optical filter using a color glass filter and dielectric material vapor-deposited film jointly.

Besides these, further features of the present embodiment will be described in the following embodiments.

### Embodiment 1

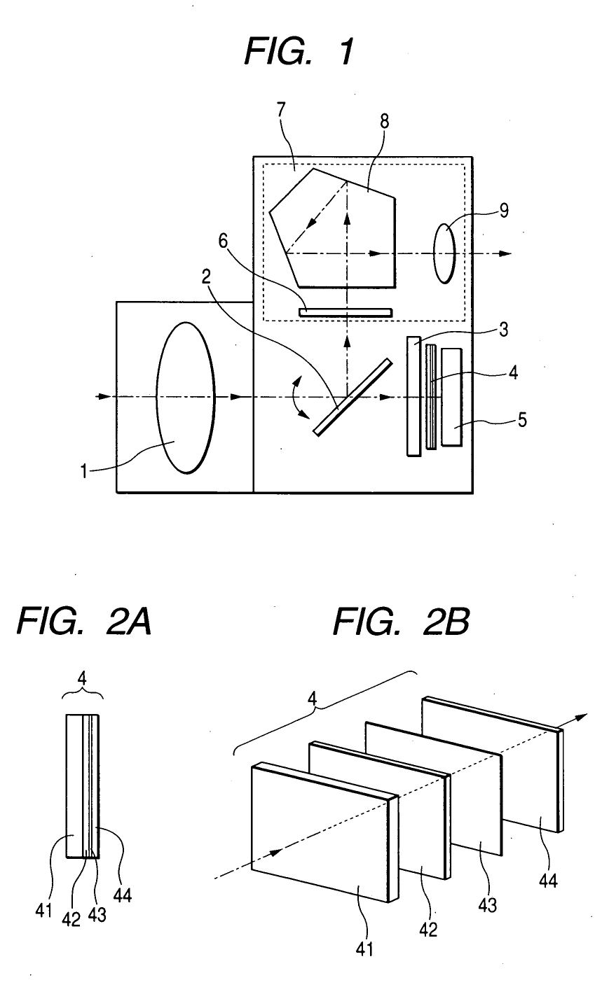

FIG. 1 is a cross-sectional view of the essential portions of a single lens reflex camera (image pickup apparatus) having an optical filter according to Embodiment 1.

In FIG. 1, the reference numeral 1 designates a photo-taking optical system as an interchangeable photo-taking lens. The reference numeral 2 denotes a pivotally movable mirror (quick return (QR) mirror) adapted to be pivotally moved as indicated by arrow A during photographing and retracted from the optical path of the photo-taking optical system 1. The reference numeral 3 designates a focal plane shutter which mechanically limits an exposure time. The reference numeral 4 denotes an optical filter according to the present invention. The optical filter 4 is disposed in the image side optical path of the photo-taking optical system 1, and is composed of a plurality of optical members which will be described later joined together. The reference numeral 5 designates an image pickup element (a solid-state image pickup element such as a CCD or a CMOS) which is disposed on the predetermined focal plane of the photo-taking optical system 1. The reference numeral 6 denotes a focusing screen on which an object image is formed by light reflected by the pivotally movable mirror 2. The reference numeral 7 designates a finder optical system having a pentaprism 8 for inverting the object image formed on the focusing, screen 6, an eyepiece 9, and the like.

In the present embodiment, the object image formed by the photo-taking optical system 1 is formed on the focusing screen 6 when the pivotally movable mirror 2 is disposed in the optical path of the photo-taking optical system. The object image formed on the focusing screen 6 is observed as a finder image through the finder optical system 7. When a photographing operation is started by a release switch, not shown, the pivotally movable mirror 2 is retracted out of the optical path of the photo-taking optical system 1, and the focal plane shutter 3 performs an opening operation, whereby the object image is formed on the image pickup surface of the image pickup element 5 through the optical filter 4. Then, an image pickup signal is outputted from the image pickup element 5, and is stored in a memory, not shown.

FIGS. 2A and 2B are illustrations of the optical filter 4 shown in FIG. 1. FIG. 2A is a cross-sectional view of the essential portions of the optical filter 4, and FIG. 2B is an exploded perspective view of the optical filter 4.

In FIGS. 2A and 2B, the reference numeral 41 denotes a wavelength selective member (optical member).

The reference numeral 42 designates a birefringence plate (first anisotropic optical member) utilizing lithium niobate.

The reference numeral 43 denotes phase film (second anisotropic optical member, organic optical member) which is constructed by elongating an organic material having optical anisotropy.

The reference numeral 44 designates a birefringence plate (third anisotropic optical member) utilizing lithium niobate.

In the present embodiment, the birefringence plate 42, the phase film 43 and the birefringence plate 44 are disposed in the named order from a light incidence side (object side) to a light emergence side (image side), to thereby constitute an optical low-pass filter for reducing response to a predetermined spatial frequency.

Also, in the present embodiment, a ray of an unnecessary wavelength range is intercepted (suppressed) by the wavelength selective member 41.

The birefringence plate 42 separates incident light into an ordinary ray in a rectilinearly polarized state having a predetermined vibration plane and an extraordinary ray by birefringent action. It has the function of moving only the extraordinary ray by a predetermined amount in a horizontal direction on a photo-taking image plane.

The optical axis of the phase film 43 is rotated by 45° with respect to a horizontal line in the plane of the film. Thereby, the phase film 43 constitutes a λ/4 plate, and has the function of converting the ray in a rectilinearly polarized state emerging from the birefringence plate 42 into a circularly polarized state by phase difference converting action.

The birefringence plate 44 separates incident light into an ordinary ray in a rectilinearly polarized state having a predetermined vibration plane and an extraordinary ray by birefringent action. It has the function of moving only the extraordinary ray by a predetermined amount in a direction perpendicular to the photo-taking image plane.

In the present embodiment, as described above, the birefringence plate 42, the phase film 43 and the birefringence plate 44 are combined together to thereby provide the function of converting the incident light into four emergent lights having substantially equal intensity at positions separate by a predetermined amount in each of a horizontal direction and a vertical direction. As the result, there is realized an optical low-pass filter which reduces the response of a predetermined spatial frequency.

The wavelength selective member 41 has, as a substrate, an optical material absorbing near ultraviolet rays (250 nm-400 nm) and near infrared rays (700 nm-1100 nm), and has optical thin film (dielectric material vapor-deposited film) reflecting the near ultraviolet rays and the near infrared rays vapor-deposited on a light passing surface, e.g. a light incidence side surface. Here, the near ultraviolet rays is intercepted in order to prevent any chemical change in the phase film 43 formed of an organic material, and the near infrared ray is intercepted in order to approximate the spectral sensitivity of the image pickup element 5 to visibility.

As the film-like organic material having optical anisotropy, use is generally made of polycarbonate resin or amorphous polyolefine resin, however, these organic materials cause yellowing deterioration due to chemical change by the application of the near ultraviolet ray. For example, in the polycarbonate resin, a wavelength which causes this yellowing deterioration is presumed to be about 290 nm and therefore, it becomes necessary to adopt such a construction as intercepts near ultraviolet ray of a wavelength in the vicinity thereof before it arrives at the phase film 43.

On the other hand, an ordinary image pickup element utilizing the photoelectric converting action of silicon has spectral sensitivity generally determined by the photoelectric converting characteristic of silicon although it has a difference due to the detailed structure of the image pickup element itself. The photoelectric converting characteristic determined here, as compared with the visibility of the human eyes, tends to become much higher in the sensitivity of the infrared wavelength range and therefore, to make the output of the image pickup element substantially equal to visibility, it becomes necessary to appropriately intercept the ray of the infrared wavelength range.

The wavelength selective member 41 in the present embodiment uses a filter substrate having the nature of transmitting therethrough a ray of a wavelength range having a spectral transmissivity characteristic nearly approximate to visibility, and absorbing the other rays. When the phase film 43 is insufficient to intercept the harmful near ultraviolet rays, and is insufficient to intercept the near infrared rays harmful to the color reproduction of the result of photographing, it is preferable to adopt a construction in which optical thin film (dielectric material vapor-deposited film) having a predetermined transmissivity characteristic is vapor-deposited on the object side surface of the wavelength selective member to thereby reflect the harmful lights of the near ultraviolet rays and the near infrared rays.

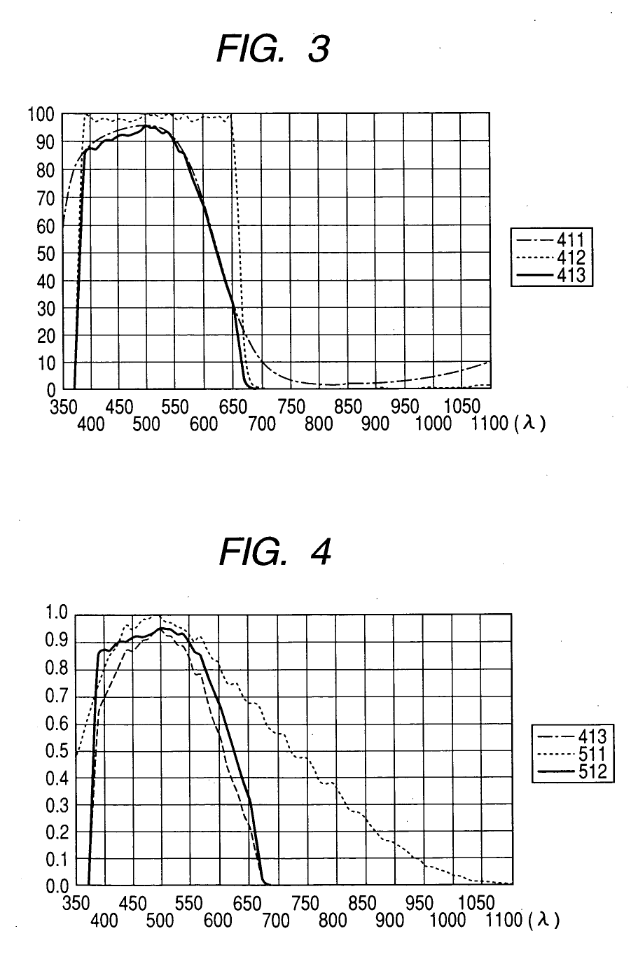

FIG. 3 shows the spectral characteristic of the optical filter 4 in the present embodiment. In FIG. 3, the reference numeral 411 indicates the spectral transmissivity characteristic of a substrate (color glass filter substrate) constituting the wavelength selective member 41. The reference numeral 412 indicates the spectral transmissivity characteristic of optical thin film vapor-deposited on the surface of the color glass filter substrate. The reference numeral 413 indicates the spectral transmissivity characteristic of the entire optical filter 4 comprising the color glass filter substrate and the optical thin film thereof combined together. In this case, the reduction in the spectral transmissivity of the other optical members constituting the optical filter 4 and the other surfaces is small, so that it can be neglected.

In the present embodiment, use is made of the wavelength selective member 41 having such a spectral transmissivity characteristic as shown in FIG. 3 to thereby reduce the transmissivity of the near ultraviolet wavelength range equal to or less than the vicinity of a wavelength 350 nm, and the transmissivity in the visible wavelength range from the vicinity of a wavelength 400 nm to the vicinity of 650 nm is maintained high, and the transmissivity of the near infrared wavelength range of a wavelength equal to or greater than the vicinity of 700 nm to a wavelength equal to the vicinity of 1100 is reduced. Particularly in the present embodiment, the spectral transmissivity characteristic of the optical thin film vapor-deposited on the incidence side surface of the color glass filter substrate is made into such a characteristic as indicated by dotted line 412 in FIG. 3, and the rays of the near ultraviolet wavelength range equal to or less than the vicinity of a wavelength 350 nm are intercepted to thereby prevent the phase film 43 formed of an organic material from deteriorating due to the chemical change thereof.

At a wavelength 350 nm, the transmissivity of the color glass filter substrate itself in the present embodiment is about 58% and the transmissivity of the optical thin film is about 0%, and in the present embodiment, design is made such that the near ultraviolet rays are substantially intercepted by the optical thin film.

Also, at a wavelength 450 nm, the transmissivity of the optical thin film is nearly 98%, and design is made such that the transmissivity of the visible wavelength range is substantially not reduced.

That is, when the transmissivity of the dielectric material vapor-deposited film used in the present embodiment at the wavelength 350 nm is defined as TUV, and the transmissivity of the dielectric material vapor-deposited film at the wavelength 450 nm is defined as TVV, design is made so as to satisfy the following conditions:
TUV<10(%) (1)
80(%)<TVV (2)
In the present embodiment, as noted above, for the conditional expressions (1) and (2), the following conditions are designed to be satisfied:
TUV in this embodiment=0(%)<10(%),
80(%)<98(%)=TVV in this embodiment.

The above-mentioned conditional expressions (1) and (2) lower the transmissivity of the near ultraviolet wavelength range at which a liquid crystalline material having birefringence and an organic material adapted to have uniaxiality by dilation cause a chemical change, and heighten the transmissivity of a visible wavelength range corresponding to visibility. If TUV and TVV don't satisfy the ranges specified in the respective conditional expressions (1) and (2), the color reproducibility of the object image will become bad, and this is not good. If as in the present embodiment, use is made of the technique of the multilayer vapor deposition of a dielectric material, good color reproducibility of the object image can be realized relatively simply by the application of an existing technique.

More preferably, the above-mentioned conditional expressions (1) and (2) may be set as follows:
0(%)≦TUV<5(%) (1a)
90(%)<TVV≦100(%) (2a)

The object light transmitted through the optical filter 4 according to the present embodiment arrives at the image pickup element 5 and is outputted as an image signal. The spectral sensitivity of an object image formed at this time is shown in FIG. 4.

In FIG. 4, the reference numeral 413 indicates relative sensitivity corresponding to the spectral transmissivity of a ray transmitted through the entire optical filter 4 shown in FIG. 3. The reference numeral 511 indicates the spectral sensitivity of the photoelectric converting portion of the image pickup element 5. The reference numeral 512 indicates the spectral sensitivity of an image pickup apparatus according to the present embodiment provided by multiplying the spectral transmissivity 413 of the entire optical filter 4 by the spectral sensitivity 511 of the image pickup element 5.

The optical filter 4 according to the present embodiment, as shown in FIG. 4, is designed to lower the transmissivity of a near infrared wavelength range equal to or greater than the vicinity of a wavelength 700 (nm) and equal to the vicinity of 1100 (nm), and also have the function of correcting the difference in spectral sensitivity between the sensitivity of the image pickup element 5 determined chiefly by the characteristic of silicon and the sensitivity of the human eyes.

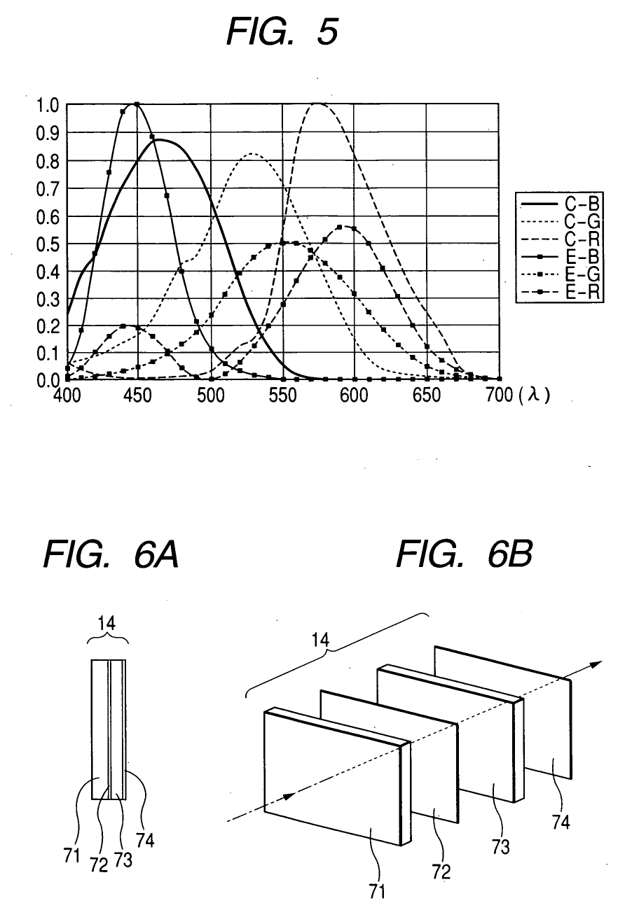

FIG. 5 shows the comparison between the spectral sensitivity of the color signal of an image pickup apparatus to which the optical filter 4 according to the present embodiment is applied and the spectral tristimulus values of the human eyes.

In FIG. 5, C-B, C-G and C-R indicate the spectral sensitivities of the three color signals of the image pickup apparatus to which the present embodiment is applied. E-B, E-G and E-R represent the spectral tristimulus values of the human eyes. As shown in FIG. 5, in the optical filter 4 according to the present embodiment, good color reproduction is made possible so that the spectral sensitivities of the color signals of the image pickup apparatus may have a characteristic similar to that of the human eyes.

As described above, in the present embodiment, with the problem in the characteristic of the organic material taken into account, there is realized an optical filter of a thin type and a high quality suitable for a single lens reflex camera particularly using an image pickup element of a large area having a color filter disposed therein in a mosaic-like manner.

### Embodiment 2

FIGS. 6A and 6B are illustrations of an optical filter according to Embodiment 2, FIG. 6A being a cross-sectional view of the essential portions thereof, and FIG. 6B being an exploded perspective view.

The difference of the present embodiment from the aforedescribed Embodiment 1 is that the optical filter 14 is constituted by a wavelength selective member 71, first birefringence film 72, a quartz phase plate 73 and second birefringence film 74 joined together in the named order from the light incidence side to the light emergence side. In the other points, the construction and optical action of the present embodiment are substantially similar to those of Embodiment 1, whereby a similar effect is obtained.

That is, in FIGS. 6A and 6B, optical thin film (dielectric material vapor-deposited film) for intercepting the harmful lights of the near ultraviolet rays and the near infrared rays is vapor-deposited on the surface (light passing surface) of a color glass filter of the wavelength selective member 71. The reference numeral 72 designates first birefringence film as a first optical member formed of a liquid crystalline material (organic material). The first birefringence film 72 separates an ordinary ray and an extraordinary ray in a plane perpendicular to the optical axis by refringent action. The reference numeral 73 denotes a quartz phase plate as a second optical member. The quartz phase plate 73 converts the phase difference between the ordinary ray and the extraordinary ray by phase difference converting action. The reference numeral 74 designates second birefringence film as a third optical member formed of a liquid crystalline material. The second birefringence film 74 separates the ordinary ray and the extraordinary ray in a plane perpendicular to the optical axis by refringent action.

In the present embodiment, the first birefringence film 72, the quartz phase plate 73 and the second birefringence film 74 are disposed in succession from the light incidence side to thereby constitute an optical low-pass filter which reduces response to a predetermined spatial frequency. Also, rays of unnecessary wavelength ranges are intercepted by the wavelength selective member 71 constituted by a color glass filter having dielectric material multilayer film vapor-deposited thereon.

According to the present embodiment, there is the feature that the optical filter 14 having a function substantially equal to that of the aforedescribed Embodiment 1 can be realized by a relatively simple construction, i.e., at a low cost.

In the construction of the present embodiment, however, when there is the wavelength dependency of the phase difference converting action of the quartz phase plate, it is preferable to make the quartz phase plate thicker.

### Embodiment 3

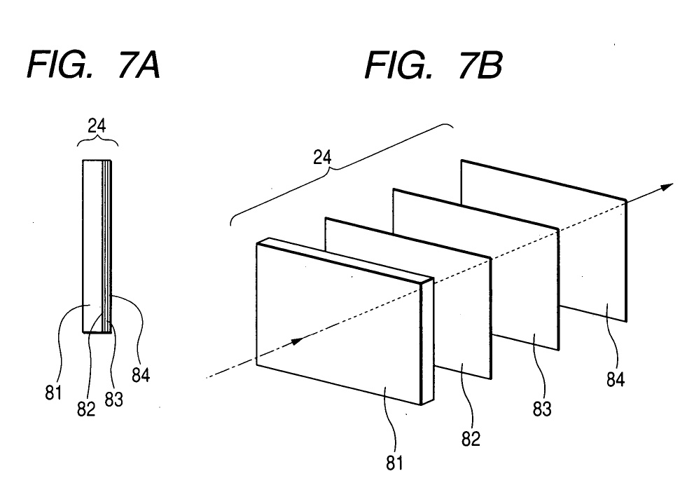

FIGS. 7A and 7B are illustrations of an optical filter according to Embodiment 3, FIG. 7A being a cross-sectional view of the essential portions of the optical filter, and FIG. 7B being an exploded perspective view of the optical filter.

The difference of the present embodiment from the aforedescribed Embodiment 1 is that the optical filter 24 is constituted by a wavelength selective member 81, first birefringence film 82, and phase film 83 and second birefringence film 84 being joined together in the named order from the light incidence side (object side). In the other points, the construction and optical action of the present embodiment are substantially similar to those of Embodiment 1, whereby a similar effect is obtained.

That is, in FIGS. 7A and 7B, reference numeral 81 denotes the wavelength selective member, and optical thin film (dielectric material vapor-deposited film) for intercepting the harmful lights of the near ultraviolet rays and the near infrared rays is vapor-deposited on the surface (light passing surface) of a color glass filter substrate. Reference numeral 82 denotes the first birefringence film as a first optical member which is formed of a liquid crystalline material (organic material). The first birefringence film 82 separates the ordinary rays and the extraordinary rays in a plane perpendicular to the optical axis by refringent action. The phase film 83 as a second optical member is constituted by dilating an organic material having optical anisotropy. The second birefringence film 84 as a third optical member is formed of a liquid crystalline material. The second birefringence film separates the ordinary rays and the extraordinary rays in a plane perpendicular to the optical axis by birefringent action.

In the present embodiment, the first birefringence film 82, the phase film 83 and the second birefringence film 84 are disposed in succession from the light incidence side to thereby constitute an optical low-pass filter which lowers response to a predetermined spatial frequency. Also, the rays of unnecessary wavelength ranges are intercepted by the wavelength selective member 81 constituted by a color glass filter substrate having dielectric material multilayer film vapor-deposited thereon.

According to the present embodiment, there is the feature that the optical filter 24 having a function substantially equal to that of the aforedescribed Embodiments 1 and 2 can be realized by being made thinner than those of the Embodiments 1 and 2.

In each of the above-described embodiments, a construction using the color glass filter and the vapor deposition of the dielectric material multilayer film jointly is adopted as the construction of the wavelength selective member for intercepting the near ultraviolet rays. However, this is not restrictive, but for example, from the balance between the manufacturing cost and the required performance, use may be made of only the color glass filter or only the vapor deposition of the dielectric material multilayer film.

As described above, in each embodiment, in an image pickup apparatus using a solid-state image pickup element such as a CCD or a CMOS, an optical filter such as a low-pass filter or a wavelength selective filter intercepting harmful lights can be made into a thin type of a high quality which can be disposed in a narrow space in the optical path of a photo-taking optical system. Particularly as an optical filter for an image pickup apparatus of a lens interchange type using a large image pickup element which requires an optical filter with a large area, there can be realized an optical filter which becomes suitable in respect of not only performance, but also manufacturing cost.

This application claims priority from Japanese Patent Application No. 2004-318201 filed on Nov. 1, 2004, which is hereby incorporated by reference herein.

What is claimed is:

1. An optical filter disposed in an optical path of an image pickup optical system, comprising:
an organic optical member formed of an organic material having optical anisotropy; and
a wavelength selective member for suppressing the passage of a light of a predetermined wavelength range, the wavelength selective member being located on a light incidence side of the organic optical member.

2. An optical filter according to claim 1, further comprising, in succession from the light incidence side to a light emergence side:
a first optical member for separating incident light into an ordinary ray and an extraordinary ray;
a second optical member for changing a phase difference between the ordinary ray and the extraordinary ray; and
a third optical member for separating the incident light into an ordinary ray and an extraordinary ray,
wherein at least one of the first, second and third optical members is the organic optical member.

3. An optical filter according to claim 1, wherein said wavelength selective member has dielectric material film, the following conditions are satisfied,
TUV <10 (%)
80 (%) <TVV
where TUV represents the transmissivity of said dielectric material film for a wavelength 350 nm, and TVV represents the transmissivity of said dielectric material film for a wavelength 450 nm.

4. An optical filter according to claim 1, wherein said wavelength selective member comprises a substrate formed of a material absorbing near ultraviolet rays and near infrared rays, and dielectric material film formed on the substrate.

5. An optical filter disposed in an optical path of an image pickup optical system, comprising, in succession from a light incidence side to a light emergence side:
a wavelength selective member for suppressing the passage of a light of a predetermined wavelength range;
a first optical member for separating incident light into an ordinary ray and an extraordinary ray;
a second optical member for changing a phase difference between the ordinary ray and the extraordinary ray; and.
a third optical member for separating the incident light into an ordinary ray and an extraordinary ray,
wherein at least one of the first, second and third optical members is formed of an organic material.

6. An optical filter according to claim 5, wherein said wavelength selective member comprises a substrate formed of a material absorbing near ultraviolet rays and near infrared rays, and dielectric material film formed on the substrate.

7. An image pickup apparatus, comprising:
an optical filter according to claim 1; and
a solid-state image pickup element on which light passed through the optical filter is incident.

8. An image pickup apparatus, comprising:
an optical filter according to claim 5; and
a solid-state image pickup element on which light passed through the optical filter is incident.
